(19) United States
(12) Patent Application Publication
(10) Pub. No.: US 2026/0228918 A1
(43) Pub. Date: Aug. 6, 2026

(54) METHOD FOR CALIBRATING A COMMON HORIZON LINE

(71) Applicant: Robert Bosch GmbH, Stuttgart (DE)

(72) Inventors: David Liepelt, Ludwigsburg (DE); Florian Tanten, Walddorfhaeslach (DE); Jai Vighneshwar Jayakumar, Gerlingen (DE); Jose Domingo Esparza Garcia, Stuttgart (DE); Matthias Mayerle, Stuttgart (DE); Maxe Hinkelmann, Fronhausen (DE); Maximilian Luzius, Boppard (DE); Richard Schoenpflug, Stuttgart (DE)

(21) Appl. No.: 19/158,297

(22) PCT Filed: Feb. 26, 2024
(86) PCT No.: PCT/EP2024/054790

§ 371 Date: Aug. 20, 2025

(30) Foreign Application Priority Data
Mar. 8, 2023 (DE) 10 2023 202 047.5

(51) Int. Cl. G06T 7/80; B60R 1/27; G06T 7/00

(52) U.S. Cl. CPC G06T 7/80; B60R 1/27; G06T 7/97; B60R 2300/102; B60R 2300/105; B60R 2300/303; B60R 2300/306; G06T 2207/30181; G06T 2207/30252

(57) ABSTRACT

A method for calibrating a common horizon line of a plurality of cameras of a motor vehicle. The cameras are arranged at different heights. The method includes: ascertaining a common horizon line for all cameras by specifying a common height value between the actual heights of the cameras; calculating a scaling factor for each camera on the basis of the common height value and the actual height of the corresponding camera; and scaling the camera image of each camera with the appropriate scaling factor, so that the horizon line of each camera is mapped to the common height value.

### FIELD

The present invention relates to a method for calibrating a common horizon line of a plurality of cameras of a vehicle, and to a device for carrying out the method.

### BACKGROUND INFORMATION

Motor vehicles according to the related art usually have many cameras, such as rear-view cameras, front cameras, rear-view mirror cameras, etc., which are mounted at different heights on the vehicle. Due to the different heights of the cameras, an image composed by these cameras would have a different horizon line.

U.S. Pat. No. US 8,259,174 B2 describes a method for estimating the horizon in a camera image to enable auto-calibration of the camera in the tilt direction. In the method, the camera is used to take two images in which horizontal edges are located. From a difference between the first and the second image, the regions in the images where no movement occurs are located. By combining the horizontal edges with the regions where no movement occurs, a horizontal edge is obtained that does not move. The camera is calibrated on the basis of this determined horizon.

An object of the present invention is to provide a method for calibrating a common horizon line of a plurality of cameras of a vehicle, with which a common horizon line is obtained in a simple manner.

The object may be achieved by a method for calibrating a common horizon line of a plurality of cameras of a vehicle. Preferred embodiments of the present invention are disclosed herein.

### SUMMARY

The present invention provides a method for calibrating a common horizon line of a plurality of cameras of a vehicle. The cameras are arranged at different heights. According to an example embodiment of the present invention, the method comprises the steps of ascertaining a common horizon line for the cameras, calculating a scaling factor for each camera on the basis of the common height value and the actual height of the corresponding camera, and scaling the camera image of each camera with the appropriate scaling factor, so that the horizon line of each camera is mapped to the common height value.

The horizon line is the line that separates the earth from the sky. Due to the different heights of the cameras on the vehicle, the horizon lines of the cameras are at different heights to one another. In order to be able to display all camera images from all cameras with a common horizon line, a common horizon line is defined. The common horizon line can be set at any actual height value. When scaling the camera image such that the camera image is adjusted to the common horizon line, each camera image also needs to be changed only slightly. It is therefore possible to display all camera images with a common horizon line.

In a preferred example embodiment of the present invention, a value which lies between the actual heights of the cameras is defined as the common height value. By setting a height value between the actual height of the cameras, the horizon lines of the cameras only need to be changed slightly, thus reducing the correction of the individual camera images.

In a further preferred example embodiment of the present invention, a mean value of all heights of the cameras is calculated as the common height value. The mean value can be calculated in various conventional ways. The mean value minimizes the sum of all corrections for the camera images from the cameras.

Preferably, a height of a camera the height of which lies between a maximum and a minimum height is used as the common height value. Such a height value has the advantage that at least for one camera no scaling factor needs to be calculated, and the corresponding camera image can be used directly. This reduces the computational effort, making the method easier to carry out.

In an advantageous further development of the present invention, a height of at least two cameras arranged at the same height, the height of which lies between a maximum and a minimum height, is used as the common height value. Due to such a method step, no scaling factor needs to be calculated for at least two cameras, which can be for example rear-view mirror cameras. The camera images from these at least two cameras can be used directly. This again significantly reduces the computational effort, making the method easier to carry out.

According to an example embodiment of the present invention, advantageously, all camera images scaled to the common height value are combined to form a 360° view. By combination of the camera images, the driver can obtain a 360° view around the vehicle, improving the overview of the vehicle and its surroundings. Because of the common horizon, it is not noticeable that these cameras are arranged at different heights.

Additionally, a device for carrying out the method of the present is provided according to the present invention. According to an example embodiment of the present invention, the device comprises at least two cameras mounted at different heights and a graphic processing unit for processing the image information from the cameras. With such a device, the mentioned advantages of the method are substantially achieved.

Exemplary embodiments of the present invention are illustrated in the figures and explained in more detail in the following description.

### BRIEF DESCRIPTION OF THE DRAWINGS

FIG. 1 shows an exemplary embodiment of a device for carrying out the method, according to the present invention.

FIG. 2 shows an exemplary embodiment of a method for calibrating a common horizon line of a plurality of cameras of a vehicle, according to the present invention.

### DETAILED DESCRIPTION OF EXAMPLE EMBODIMENTS

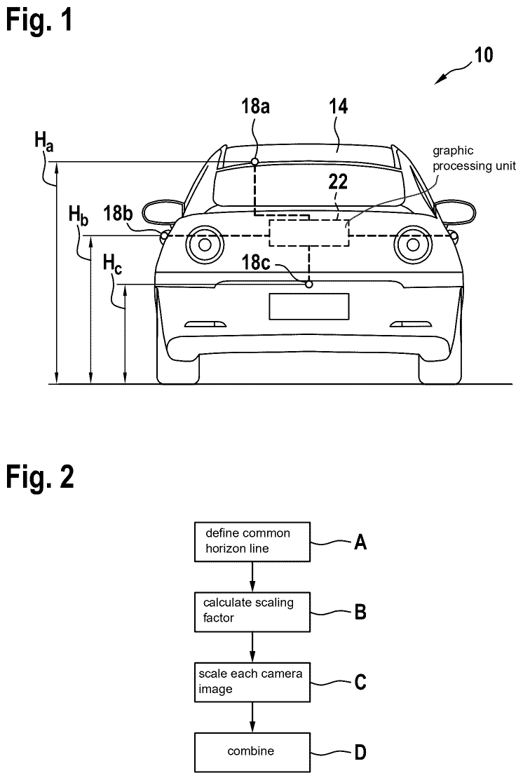

FIG. 1 shows an exemplary embodiment of a device 10 for carrying out the method. The device 10 comprises a motor vehicle 14 on which a plurality of cameras 18a, 18b, 18c are arranged at different heights Hₐ, H_{b}, H_{c} from the ground. In addition, a graphic processing unit 22 is provided, which is connected to all cameras 18a, 18b, 18c and via which the method according to the present invention can be carried out.

FIG. 2 shows an exemplary embodiment of a method for calibrating a common horizon line of a plurality of cameras of a vehicle. In a first step A, a common horizon line is defined for all cameras 18a, 18b, 18c. The height value of this common horizon line lies between the actual height values Hₐ, H_{b}, H_{c} of the cameras 18a, 18b, 18c. In a second step B, a scaling factor is calculated for each camera 18a, 18b, 18c on the basis of the common height value and the actual height Hₐ, H_{b}, H_{c} of the camera 18a, 18b, 18c. On the basis of this scaling factor, the camera image of each camera 18a, 18b, 18c is scaled in a next step C. This maps the horizon line of each camera 18a, 18b, 18c to the common height value. In a next step D, all camera images scaled to the common height value are combined to form a 360° view. This allows the driver to be shown a 360° view formed from all cameras 18a, 18b, 18c, which view has a common horizon line.

Using this method, it is easily possible to normalize camera images from cameras 18a, 18b, 18c mounted at different heights Hₐ, H_{b}, H_{c} to a common horizon line.

1-7. (canceled)

8. A method for calibrating a common horizon line of a plurality of cameras of a motor vehicle which are arranged at different heights, the method comprising the following steps:
ascertaining a common horizon line for all of the cameras by specifying a common height value for the cameras;
calculating a respective scaling factor for each camera of the cameras based on the common height value and an actual height of the camera; and
scaling a camera image of each camera with the respective scaling factor, so that a respective horizon line of each camera is mapped to the common height value;
wherein a value is defined as the common height value which lies between the actual heights of the cameras on the motor vehicle, and a height of a camera of the cameras whose height lies between a maximum and a minimum height is used as the common height value.

9. The method according to claim 8, wherein a mean value of all heights of the cameras is calculated as the common height value.

10. The method according to claim 8, wherein a height of at least two cameras arranged at the same height, the height of which lies between the maximum and the minimum height, is used as the common height value.

11. The method according to claim 8, wherein all camera images scaled to the common height value are combined to form a 360° view.

12. A device, comprising:
at least two cameras which are mounted at different heights ; and
a graphic processing unit configured to process image information of the cameras;
wherein the device is configured to calibrate a common horizon line of the cameras, the device configured to:
ascertain a common horizon line for all of the cameras by specifying a common height value for the cameras,
calculate a respective scaling factor for each camera of the cameras based on the common height value and an actual height of the camera, and scale a camera image of each camera with the respective scaling factor, so that a respective horizon line of each camera is mapped to the common height value,
wherein a value is defined as the common height value which lies between the actual heights of the cameras on the motor vehicle, and a height of a camera of the cameras whose height lies between a maximum and a minimum height is used as the common height value.
